(19) United States
(12) Patent Application Publication
(10) Pub. No.: US 2003/0000096 A1
(43) Pub. Date: Jan. 2, 2003

(54) Joint structure for folding rule

(76) Inventor: Chien-Kuo Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/892,496

(22) Filed: Jun. 28, 2001

(51) Int. Cl. G01B 3/06; B43L 7/10

(52) U.S. Cl. 33/458

(57) ABSTRACT

A folding rule includes a first stick having a first hole with a plurality of first protrusions located radially around the first hole. A second stick has a second hole with a plurality of second protrusions located radially around the second hole. A rivet has a resilient member mounted thereto and extends through the first hole and the second hole. The first protrusions are engaged with grooves defined between the second protrusions. The resilient member is compressed so as to disengage the first protrusions on the first stick from the grooves in the second stick. By this way, the first stick is pivoted relative to the second stick.

### FIELD OF THE INVENTION

The present invention relates to a folding rule wherein each stick has a plurality of protrusions and grooves are defined between the protrusions. The protrusions on a first stick are engaged with the grooves in a second stick. A resilient member is connected between the overlapped portion of the two sticks.

### BACKGROUND OF THE INVENTION

A conventional folding rule generally includes a plurality of sticks and each stick has marks on a surface thereof. The sticks are pivotally connected with each other by rivets connecting overlap portions of two sticks so that the stick can be pivoted relative to the other. The folding rule can be used to measure peripheral length of an angled object by contacting the sticks on the sides of the angled of the object. However, the sticks are not easily be maintain their portions when the two sticks are opened at an angle. In other words, the sticks could be moved to change the desired angle between the two sticks and the user has to re-arrange the two sticks again.

### SUMMARY OF THE INVENTION

In accordance with one aspect of the present invention, there is provided a folding rule which comprises a first stick having a first hole defined therethrough and a plurality of first protrusions extend from a surface of the first stick and are located radially around the first hole. A plurality of first grooves are defined between the first protrusions. A second stick has a second hole defined therethrough and a plurality of second protrusions 111′ extend from a surface of the second stick. The second protrusions are located radially around the second hole and a plurality of second grooves are defined between the second protrusions. A rivet has a resilient member mounted thereto and extends through the first hole and the second hole. The first protrusions are engaged with the second grooves and the second protrusions are engaged with the first grooves.

The primary object of the present invention is to provide a folding rule wherein the two sticks can be positioned at several angles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the folding rule of the present invention;

FIG. 2 is an exploded view to show two sticks, the rivet and the resilient member;

FIG. 3 is a cross sectional view to show when the protrusions on the two sticks contact head to head by compressing the resilient member;

FIG. 4 is a cross sectional view to show when the protrusions on the first stick are engaged with the second grooves on the second stick, while the resilient member is not compressed, and

FIG. 5 shows that the two sticks can be positioned at different angles.

### DETAILED DESCRIPTION OF THE PREFERRED EMBODIMENT

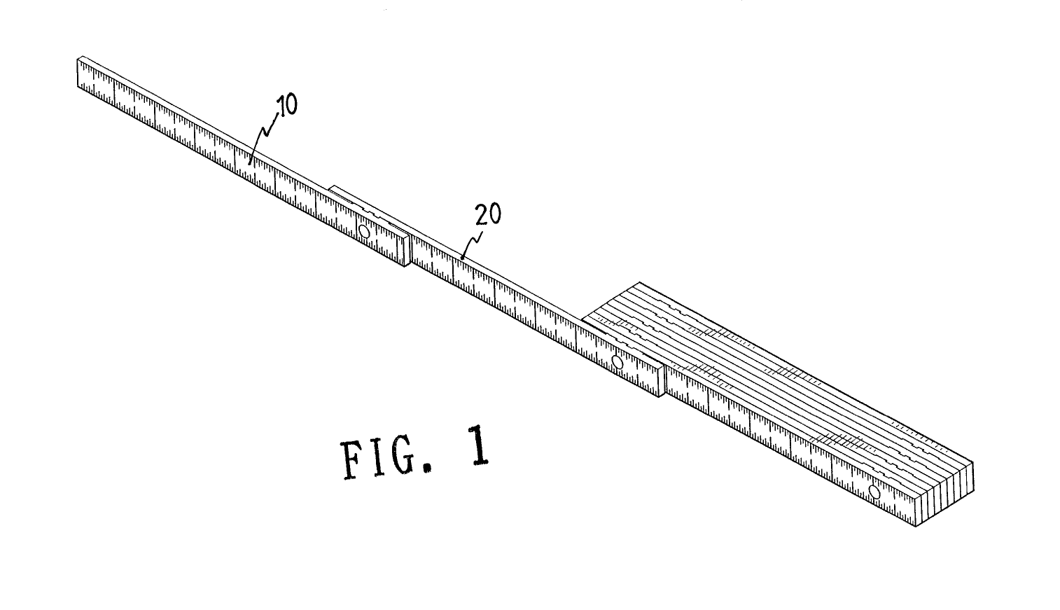

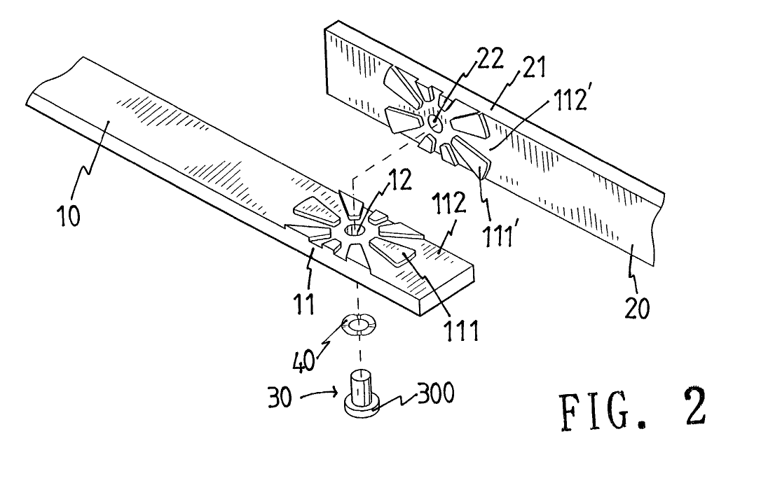

Referring to FIGS. 1 and 2, the folding rule of the present invention comprises a first stick 10 having a first hole 12 defined therethrough and a plurality of first protrusions 111 extend from a surface of the first stick 10. The first protrusions 111 are located radially around the first hole 12 and a plurality of first grooves 112 are defined between the first protrusions 111. A second stick 20 has a second hole 22 defined therethrough and a plurality of second protrusions 111′ extend from a surface of the second stick 20. The second protrusions 111′ are located radially around the second hole 22 and a plurality of second grooves 112′ are defined between the second protrusions 111′.

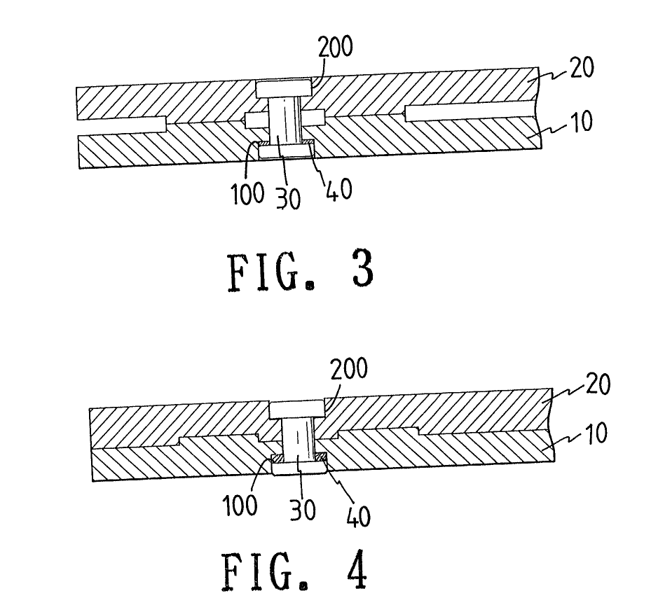

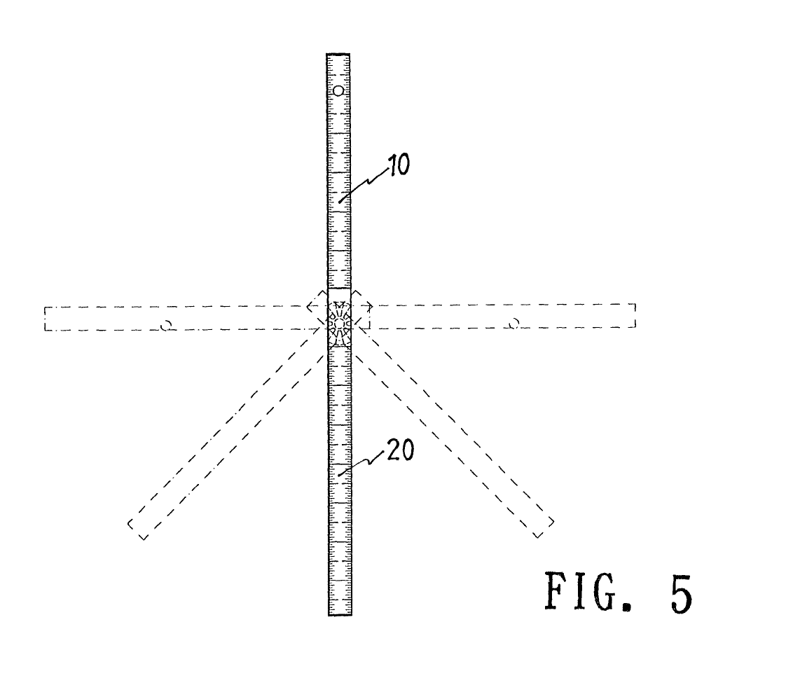

Referring to FIGS. 3 and 4, the first stick 10 has a recess 100 defined in the other surface which is located in opposite side of the surface having the first protrusions 111, and the recess 100 communicates with the first hole 12. The second stick 20 has a recess 200 defined in the other surface which is located in opposite side of the surface having the second protrusions 111′, and the recess 200 communicates with the second hole 22.

A rivet 30 has a flange 300 and a shank extending from the flange 300. A resilient member 40 is mounted to the shank which extends through the first hole 12 and the second hole 22, and is machined to have an other flange received in the recess 200. The resilient member 40 is located between the first flange 300 and an inside of the recess 100. The first protrusions 111 are engaged with the second grooves 112′ and the second protrusions 111′ are engaged with the first grooves 112. When pulling the second stick 20 away from the first stick 10, the resilient member 40 is compressed and the first protrusions 111 contact head to head the second protrusions 111′ as shown in FIG. 3. As shown in FIG. 4, when pivoting the first stick 10, the first protrusions 111 are engaged with the second grooves 112′ at another angle. Therefore, the two sticks 10, 20 can be positioned at different angles.

While we have shown and described the embodiment in accordance with the present invention, it should be clear to those skilled in the art that further embodiments may be made without departing from the scope of the present invention.

What is claimed is:

1. A folding rule comprising:
a first stick having a first hole defined therethrough and a plurality of first protrusions extending from a surface of said first stick, said first protrusions located radially around said first hole, a plurality of first grooves defined between said first protrusions;
a second stick having a second hole defined therethrough and a plurality of second protrusions extending from a surface of said second stick, said second protrusions located radially around said second hole, a plurality of second grooves defined between said second protrusions, and
a rivet having a resilient member mounted thereto and extending through said first hole and said second hole, said first protrusions engaged with said second grooves and said second protrusions engaged with said first grooves.

2. The folding rule as claimed in claim 1, wherein said first stick has a recess which communicates with said first hole, said rivet having a flange and a shank extending from said flange, said resilient member mounted to said shank and located between said first flange and an inside of said recess.
